(19) United States
(12) Patent Application Publication
(10) Pub. No.: US 2018/0246636 A1
(43) Pub. Date: Aug. 30, 2018

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: Yoshiteru Horiike, Matsudo-shi (JP)

(21) Appl. No.: 15/900,508

(22) Filed: Feb. 20, 2018

(30) Foreign Application Priority Data
Feb. 28, 2017 (JP) 2017-035934

(51) Int. Cl. G06F 3/0485; G06F 3/0488; G06F 3/12

(52) U.S. Cl. CPC G06F 3/04855; G06F 3/1256; G06F 3/1204; G06F 3/04883

(57) ABSTRACT

Setting is performed such that, out of screens in which a predetermined touch operation is detected, scroll display is not performed even when the touch operation is detected in some screens and scroll display is performed when the touch operation is detected in the other screens. For that purpose, a control method for an image processing apparatus includes displaying at least a first screen and a second screen, scroll-displaying, according to a predetermined touch operation by a user on a first region of the first screen, an item that is displayed in the first region and scroll-displaying, according to the predetermined touch operation by the user on a second region of the second screen, an item that is displayed in the second region, and performing a setting to prevent scroll display that is based on the predetermined touch operation from being performed in the second region.

### BACKGROUND

### Field of the Disclosure

Aspects of the present disclosure generally relate to an image processing apparatus, a control method for an image processing apparatus, and a storage medium.

### Description of the Related Art

In recent years, image processing apparatuses equipped with a touch panel (touchscreen) have often been used. Such an image processing apparatus is able to detect a touch operation performed by the user to switch a screen displayed on a display. The touch operation, which the image processing apparatus is able to detect, includes a tap operation in which the user touches the touch panel with a fingertip and then releases the fingertip from the touch panel without moving the fingertip on the touch panel and includes a flick operation in which the user touches the touch panel with a fingertip and then moves the fingertip on the touch panel in such a way as to perform sweeping.

Japanese Patent Application Laid-Open No. 2015-14888 discusses displaying a preview image stored in an image processing apparatus on a display unit. Upon detection of a flick operation, the image processing apparatus switches pages of a preview image to be displayed on the display unit from one page to a new page and displays the new page.

Japanese Patent Application Laid-Open No. 2015-195005 discusses performing, in response to a flick operation performed along a vertical direction on an address book screen, scroll display of a destination list registered with an address book in a direction in which the flick operation has been performed. In a case where a great number of destinations are included in the address book, it is impossible to display all of the destinations at a time. Therefore, upon detection of a flick operation, an image processing apparatus performs scroll display in such a way as to hide a part of destinations that are being displayed and display a part of destinations that have been hidden. Moreover, such an image processing apparatus as mentioned above allows performing a tap operation on a destination intended to be selected from among destinations that are being displayed on the address book screen and thus setting the selected destination as a destination of image data.

As with the address book screen, a screen that allows selecting a destination with a tap operation and performing scroll display of a list with a flick operation may give rise to the following issues. For example, with regard to an address book screen illustrated in FIG. 16, the user presses a touch panel to select a destination. If, after pressing the touch panel, the user has inadvertently moved the finger on the touch panel in a direction indicated by an arrow 208, the destination list would be scroll-displayed, so that the user cannot the select the destination.

Therefore, with regard to such an image processing apparatus as mentioned above, there is known a method of setting a flick operation as disabled, thus facilitating selection of an item with a tap operation. If a flick operation is set as disabled, the image processing apparatus does not perform scroll display of a screen even when detecting the flick operation. With this method employed, even if, after the user presses the touch panel while intending to perform a tap operation, the fingertip inadvertently moves on the touch panel, the destination list can be prevented from being scroll-displayed.

Conventionally, in a case where there is a plurality of screens in which scroll display that is based on a flick operation is able to be performed, such a setting as to prevent scroll display that is based on a flick operation with respect to some screens and to allow scroll display that is based on a flick operation with respect to the other screens has not been available. Moreover, in a case where, in one screen, there is a plurality of regions in which scroll display that is based on a flick operation is able to be performed, such a setting as to prevent scroll display that is based on a flick operation with respect to some regions and to allow scroll display that is based on a flick operation with respect to the other regions has not been available.

For example, with regard to a screen in which a preview image that is being displayed is not selected even when a tap operation is detected, such as a preview screen, scroll display is performed upon detection of a flick operation. On the other hand, with regard to a screen in which, when a flick operation is detected, a list is scroll-displayed and, when a tap operation is detected, a destination on which the tap operation has been performed is selected, such as an address book screen, such a setting as to prevent scroll display even when a flick operation is detected has not been available. Therefore, if a flick operation is set as disabled, scroll display that is based on a flick operation will not be performed even on to a screen in which a preview image is not selected even when a tap operation is detected, such as a preview screen, so that the user operability may decrease.

### SUMMARY

According to an aspect of the present disclosure, an image processing apparatus includes a display unit configured to display at least a first screen and a second screen, a display control unit configured to scroll-display, according to a predetermined touch operation by a user on a first region of the first screen, an item that is displayed in the first region and configured to scroll-display, according to the predetermined touch operation by the user on a second region of the second screen, an item that is displayed in the second region, and a setting unit configured to perform a setting to prevent scroll display that is based on the predetermined touch operation from being performed in the second region by the display control unit.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of an image processing apparatus according to exemplary embodiments of the present disclosure.

FIGS. 2A, 2B, 2C, 2D, and 2E are diagrams each illustrating an example of a screen used to select a destination of image data, which is displayed on a display of the image processing apparatus according to exemplary embodiments of the present disclosure.

FIGS. 3A and 3B each illustrate an example of a screen for displaying a preview image, which is displayed on the display of the image processing apparatus according to exemplary embodiments of the present disclosure.

FIGS. 4A and 4B each illustrate an example of a screen for setting enablement/disablement of a flick operation, which is displayed on a display of an image processing apparatus according to a first exemplary embodiment of the present disclosure.

FIGS. 5A and 5B each illustrate an example of a screen which is displayed on the display when a flick operation is set as disabled in the image processing apparatus according to the first exemplary embodiment.

FIG. 6 is a flowchart illustrating processing which the image processing apparatus performs when displaying a screen on the display in the first exemplary embodiment.

FIG. 7 is a flowchart illustrating processing which the image processing apparatus performs upon receiving a touch operation in the first exemplary embodiment.

FIG. 8 illustrates an example of a screen used to select a destination of image data, which is displayed on a display of an image processing apparatus according to a second exemplary embodiment of the present disclosure.

FIG. 9 is a flowchart illustrating an example of processing which the image processing apparatus performs when displaying a screen on the display in the second exemplary embodiment.

FIG. 10 illustrates an example of a screen used to select a destination of image data, which is displayed on a display of an image processing apparatus according to a third exemplary embodiment of the present disclosure.

FIG. 11 is a flowchart illustrating an example of processing which the image processing apparatus performs after displaying a screen on the display in the third exemplary embodiment.

FIG. 12 is a diagram illustrating an example of a screen which is displayed on a display of an image processing apparatus in a fourth exemplary embodiment of the present disclosure.

FIG. 13 is a flowchart illustrating an example of processing which the image processing apparatus performs when displaying a screen on the display.

FIGS. 14A, 14B, 14C, 14D, and 14E are diagrams each illustrating an example of a screen which is displayed on a display of an image processing apparatus in a fifth exemplary embodiment of the present disclosure.

FIG. 15 is a flowchart illustrating processing which the image processing apparatus performs when displaying a screen on the display in the fifth exemplary embodiment.

FIG. 16 is a diagram illustrating an example of a user operation performed when a screen used to select a destination of image data is displayed on a display.

### DESCRIPTION OF THE EMBODIMENTS

### <Hardware Configuration of Image Processing Apparatus>

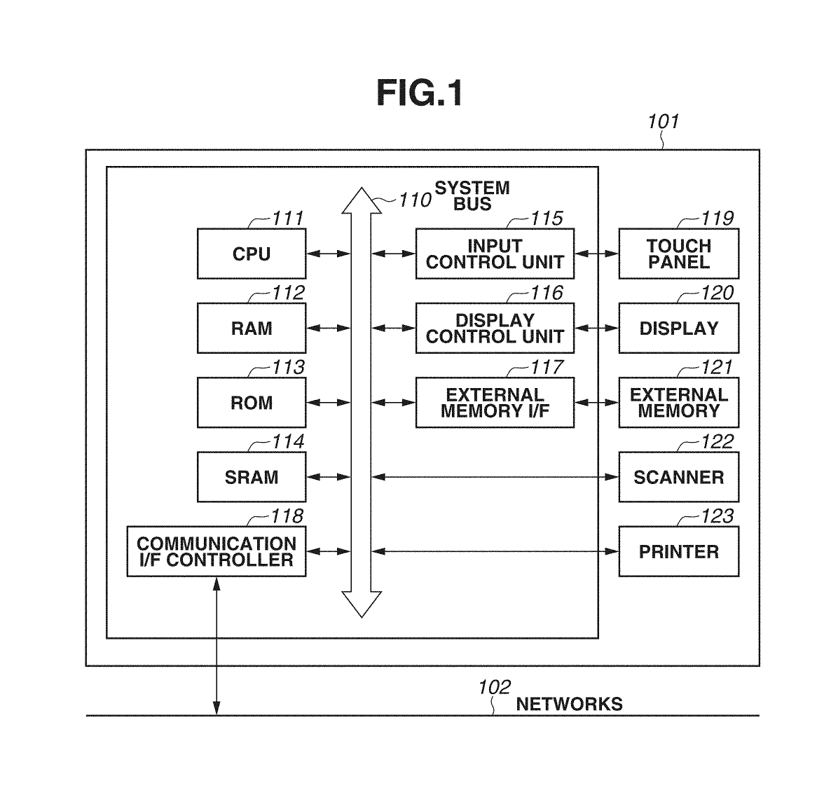

FIG. 1 is a diagram illustrating a hardware configuration of an image processing apparatus 101 to which exemplary embodiments of the present disclosure can be applied. The image processing apparatus 101 is, for example, a multifunction peripheral (MFP).

The image processing apparatus 101 includes a central processing unit (CPU) 111 to a printer 123. The CPU 111, a random access memory (RAM) 112, a read-only memory (ROM) 113, an input control unit 115, a display control unit 116, an external memory interface (I/F) 117, and a communication I/F controller 118 are connected to a system bus 110. Moreover, a touch panel 119, a display 120, and an external memory 121 are connected to the system bus 110. The various processing units are configured to be able to exchange data with each other via the system bus 110.

The ROM 113 is a non-volatile memory, in which, for example, image data, other pieces of data, and various programs according to which the CPU 111 operates are stored in respective predetermined regions thereof. The RAM 112 is a volatile memory, which is used as a temporary storage region, such as a main memory or a work area, for the CPU 111. The CPU 111 controls each unit of the image processing apparatus 101 according to the programs stored in, for example, the ROM 113 while using the RAM 112 as a work memory. Furthermore, the programs according to which the CPU 111 operates are previously stored in not only the ROM 113 but also the external memory 121, such as a hard disk. A static random access memory (SRAM) 114 is a non-volatile recording medium capable of performing high-speed operation.

The input control unit 115 receives a user operation, generates a control signal corresponding to the user operation, and supplies the control signal to the CPU 111. For example, the input control unit 115 receives a user operation from a keyboard (not illustrated) functioning as an input device, a mouse (not illustrated), or the touch panel 119. Furthermore, the touch panel 119 is, for example, an input device configured to output coordinate information corresponding to a position at which a touch operation has been performed with respect to an input control unit constructed in a planar or elevational manner. The CPU 111 controls each unit of the image processing apparatus 101 based on a control signal generated by the input control unit 115 according to a user operation performed on the input device. This enables the image processing apparatus 101 to perform an operation corresponding to the user operation.

The display control unit 116 outputs, to the display 120, a display signal to cause the display 120 to display an image. For example, the CPU 111 supplies a display control signal generated according to a program to the display control unit 116. The display control unit 116 generates a display signal based on the display control signal and outputs the display signal to the display 120.

Furthermore, the touch panel 119 is configured integrally with the display 120 and also functions as an operation unit. For example, a touch panel 119 that has a light transmittance that does not hinder a displaying operation of the display 120 is attached to the upper layer of a display surface of the display 120. Input coordinates in the touch panel 119 are associated with display coordinates on the display 120. This configures a graphical user interface (GUI) which allows the user to intuitively perform an operation on a screen displayed on the display 120.

The external memory I/F 117 is an interface used to mount the external memory 121, such as a hard disk, a floppy disk, a compact disc (CD), a digital versatile disc (DVD), or a memory card. The external memory I/F 117 reads data from the mounted external memory 121 and writes the data into the external memory 121 based on a control operation of the CPU 111. The communication I/F controller 118 is an interface used to perform communications with various networks 102, such as a local area network (LAN), the Internet, a wired network, and a wireless network based on a control operation of the CPU 111. Various devices, such as a personal computer (PC), another MFP, a printer, and a server, are connected to the networks 102 in such a way as to be able to perform communication with the image processing apparatus 101.

A scanner 122 reads an original to generate image data. A printer 123 performs print processing based on an instruction from the user input via the input control unit 115 or a command input from an external apparatus via the communication I/F controller 118. Furthermore, the CPU 111 functions as a specifying unit, which is able to specify, for example, the following touch operations or states on the touch panel 119. The operations which the CPU 111 is able to specify includes, for example, the user touching the touch panel with the finger or pen (hereinafter referred to as pressing), the finger or pen moving while being kept in touch with the touch panel (hereinafter referred to as moving), and the user releasing the finger or pen from the touched touch panel (hereinafter referred to as releasing). Moreover, the CPU 111 determines what the input touch operation is based on a combination of the above-mentioned pressing, moving, and releasing. The touch operations include, for example, a tap operation of touching the touch panel with the finger or pen and then releasing the finger or pen from the touch panel without moving the finger or pen a predetermined distance or more and a drag operation of pressing the touch panel with the finger or pen and then releasing the finger or pen from the touch panel after moving the finger or pen on the touch panel. Moreover, an operation in which the user presses the touch panel, performs dragging on the touch panel, and then releases the finger with such a movement as to perform quick sweeping on the touch panel is referred to as a flick operation.

The touch panel 119 can be a touch panel of any type selected from various types, such as a resistance film type, a capacitance type, a surface acoustic wave type, an infrared type, an electromagnetic induction type, an image recognition type, and an optical sensor type.

The image processing apparatus 101 is able to store image data in the RAM 112 or the external memory 121. For example, the image processing apparatus 101 stores image data generated by reading an original with the scanner 122 in the RAM 112 or the external memory 121. Moreover, the image processing apparatus 101 stores image data received from an external apparatus, such as a PC connected to the networks 102 via the communication I/F controller 118, in the RAM 112 or the external memory 121. Furthermore, the image processing apparatus 101 stores image data received from an attachable and detachable storage medium (for example, a universal serial bus (USB) memory or a memory card) mounted on the external memory I/F 117 in the RAM 112 or the external memory 121. Besides, the image processing apparatus 101 can store image data in the RAM 112 or the external memory 121 according to another storage method. Furthermore, image data to be stored in the RAM 112 or the external memory 121 can be data obtained by reflecting various setting contents, including print setting contents in the original read by the scanner 122. Additionally, image data can be a sample image previously stored in the RAM 112 or the external memory 121.

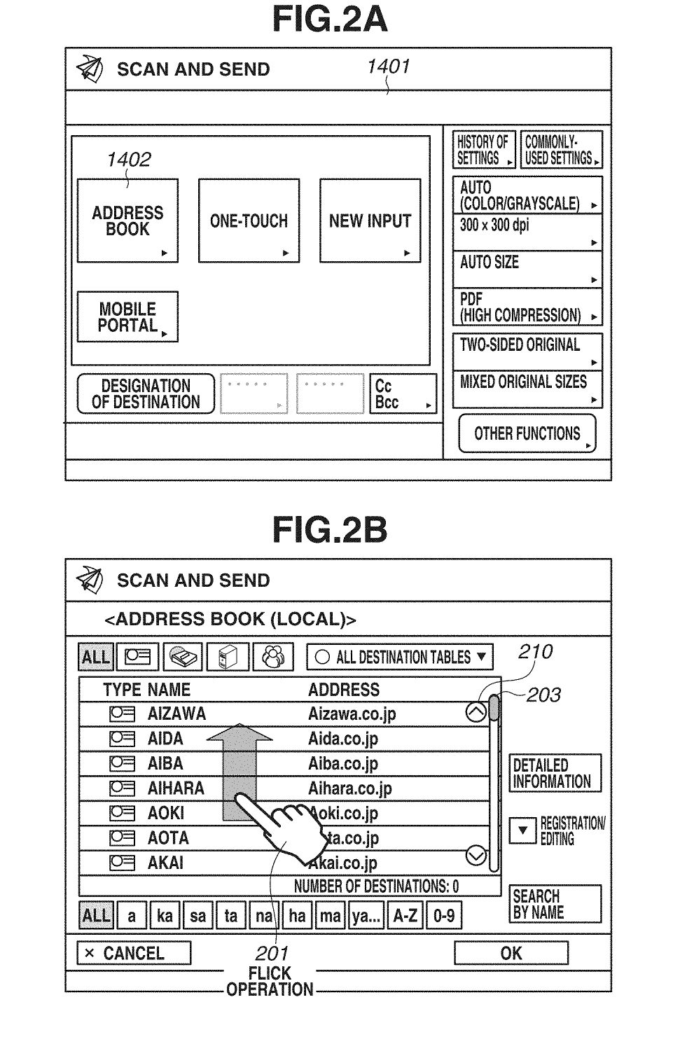

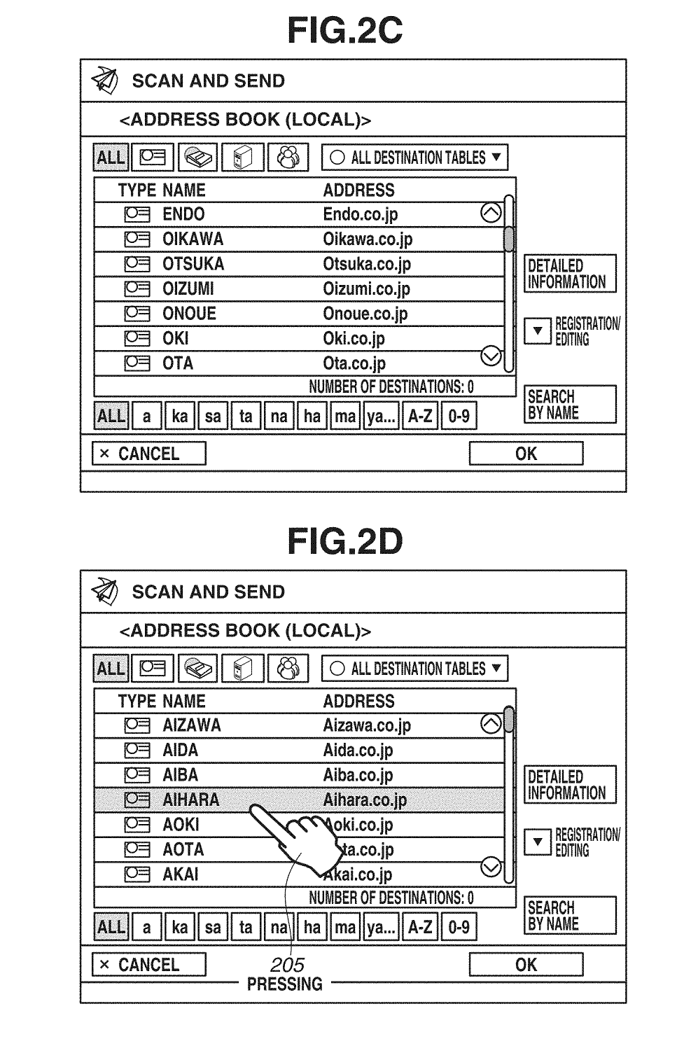

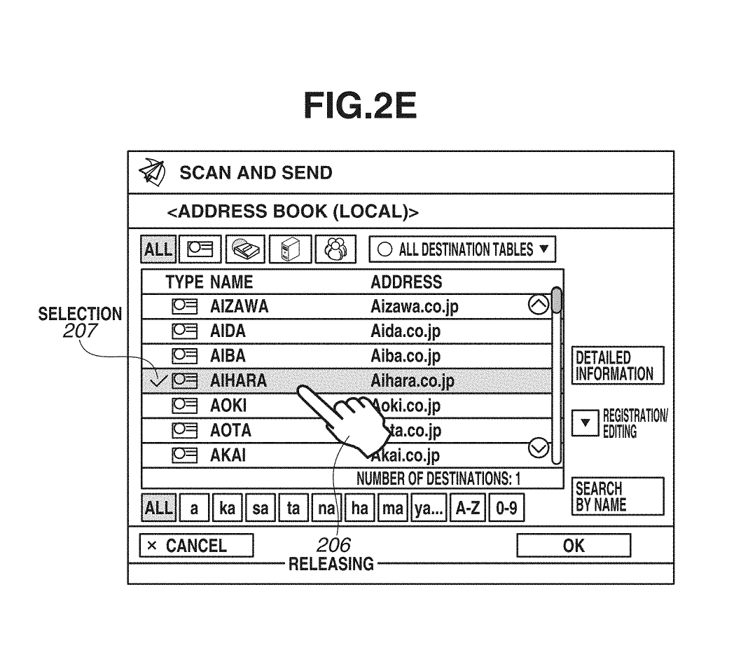

An operation performed when flick is set as enabled, processing performed when flick is set as disabled, and a method for setting enablement/disablement of flick in the image processing apparatus 101 are described with reference to FIGS. 2A, 2B, 2C, 2D, and 2E to FIGS. 5A and 5B.

In the first exemplary embodiment, in a case where the flick operation is set as enabled, with respect to all of the regions in which scroll display is able to be performed upon detection of the flick operation, scroll display is performed upon detection of the flick operation. On the other hand, in a case where the flick operation is set as disabled, with respect to a predetermined region, scroll display is performed according to detection of the flick operation, and with respect to the other regions, scroll display is not performed even upon detection of the flick operation.

FIGS. 2A to 2E are diagrams each illustrating an example of an address book screen which is displayed on the display 120 of the image processing apparatus 101 when the flick operation is set as enabled. The following description describes an operation performed by the user to select a destination from a destination list displayed on the display 120 and screens which are displayed during that operation with reference to FIGS. 2A to 2E.

FIG. 2A illustrates a screen which is displayed on the display 120 when the user selects “scan and send”, which uses a send function, in a menu screen used to select a function to be used. The “scan and send” screen 1401 is a screen used by the user to perform settings to use the send function. For example, the user is allowed to set a destination to which to send image data generated by reading an original with the scanner 122 or to set whether an original to be read by the scanner 122 is a one-sided printed original or a two-sided printed original. Here, a case where the user has performed a tap operation on an “address book” button 1402 for selection thereof is described for example.

FIG. 2B illustrates a screen which is displayed on the display 120 when the user selects the “address book” button 1402 in the “scan and send” screen 1401. The address book screen is a screen used to select a destination with a tap operation and to scroll-display a destination list with a flick operation. Data about the address book is stored in the external memory 121 of the image processing apparatus 101. In a case where the number of destinations registered with the address book is great, it is impossible to display all of the destinations on the screen at a time. Therefore, the user performs a flick operation 201 on the destination list to scroll-display the destination list. In this way, the address book screen is a screen including a region available for performing scroll display that is based on a flick operation.

As the user performs the flick operation 201 upward as illustrated in FIG. 2B, the destination list that is being displayed is scroll-displayed upward, so that a screen illustrated in FIG. 2C is displayed on the display 120. Scroll-displaying the destination list causes at least a part of destinations that have been displayed to become hidden and causes at least a part of destinations that have been hidden to become displayed on the display 120.

Referring to FIG. 2B, when the user performs the flick operation 201, “AIZAWA” to “AKAI”, which have been displayed, become hidden. On the other hand, “ENDO” to “OTA”, which have been hidden, become displayed. Here, a case where all of the destinations which have been displayed prior to the flick operation become hidden and destinations which have been hidden become displayed has been described for example. However, a part of the destinations which have been displayed can become hidden and destinations which have been hidden can become displayed.

The address book screen is also able to be scroll-displayed by an operation other than the flick operation. For example, when the user performs a drag operation in a region in which destinations are being displayed, the destination list is scroll-displayed. The drag operation is an operation in which, after pressing the touch panel 119, the user moves the finger without releasing the finger from the touch panel 119 and then releases the finger from the touch panel 119. This method causes the display list to be scroll-displayed according to a distance by which the user has moved the finger from the position of pressing to the position of releasing.

Furthermore, when the user performs a drag operation on a scroll bar 203 displayed on the display 120, scroll display can be performed. More specifically, the user presses a displayed portion of the scroll bar 203 on the display 120, and then performs a drag operation. This method causes the display list to be scroll-displayed according to the amount of movement of the scroll bar 203.

When the user presses a scroll button 210 displayed on the display 120, scroll display can also be performed. More specifically, the user presses a displayed portion of the scroll button 210 (an up or down arrow key) on the display 120, and then keeps the pressed state of the scroll button 210. This method causes the display list to be scroll-displayed according to a time during which pressing of the scroll button 210 is continued. The operation method for performing scroll display is not limited to these four methods, which include the above-mentioned methods and the flick operation.

FIGS. 2D and 2E are diagrams each illustrating a selection operation to select an optional destination from the destination list in the address book screen. The user performs a tap operation on a destination intended to be selected from the destination list, thus selecting the destination.

FIG. 2D illustrates an example of a screen which is displayed on the display 120 when the user has performed pressing 205 on a destination “AIHARA”. According to the user pressing a destination intended to be selected, the image processing apparatus 101 inverts the color of the pressed destination.

FIG. 2E illustrates an example of a screen which is displayed on the display 120 when the user has performed releasing 206 of the finger on the destination “AIHARA”. According to the user releasing the finger, the image processing apparatus 101 selects the pressed destination. For example, in FIG. 2E, the image processing apparatus 101 displays a “selection” mark 207. The user performs this series of operations illustrated in FIGS. 2D and 2E to select a destination.

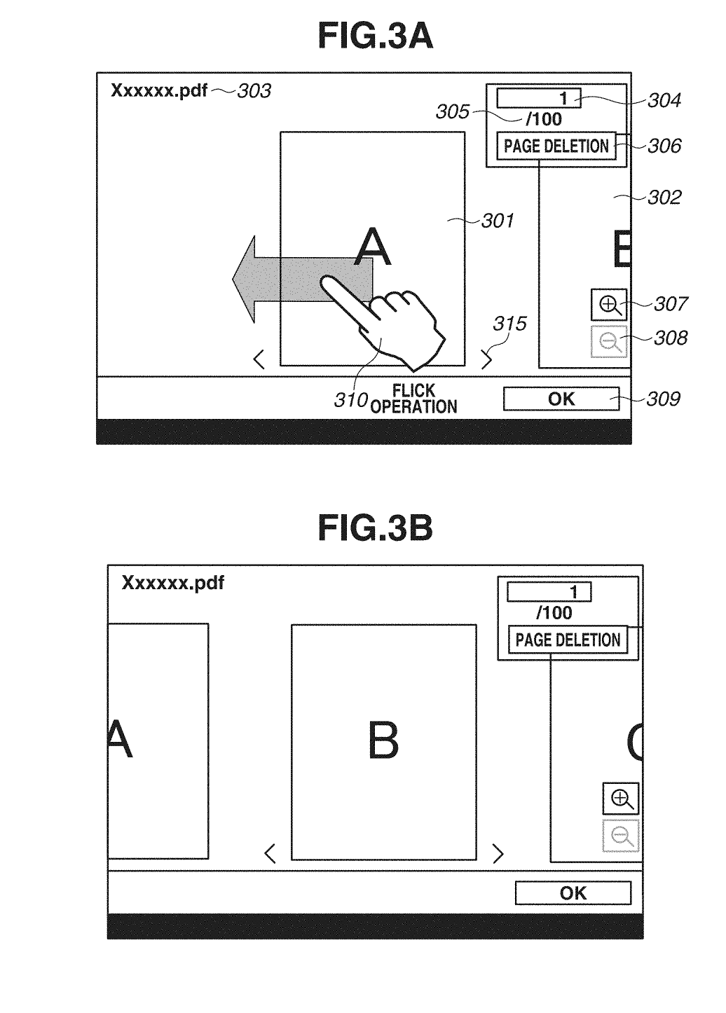

FIGS. 3A and 3B are diagrams each illustrating a preview screen which is displayed on the display 120 of the image processing apparatus 101 when a flick operation is set as enabled.

FIGS. 3A and 3B each illustrate an example of a preview screen for displaying a preview image of image data read by the image processing apparatus 101 with, for example, a scanner. In the preview screen, when the user performs a flick operation, preview images which are displayed on the display 120 are scroll-displayed. Moreover, in the preview screen, when the user performs a tap operation on a preview image, the image processing apparatus 101 switches screens and enlarges the preview image. The region in which the preview image is displayed is a region in which scroll display that is based on a flick operation is able to be performed, and the preview screen is a screen including the region in which scroll display that is based on a flick operation is able to be performed.

A configuration of the preview screen is described with reference to FIG. 3A. A preview image A 301 and a preview image B 302 are pieces of image data stored in the ROM 113 or the external memory 121. A preview image to be displayed in the preview screen can be image data stored in the ROM 113 or the external memory 121 or can be an image generated by reflecting print settings in image data.

A file name display region 303 is a region for displaying a file name associated with a preview image that is being displayed. In a case where no file name is associated with a preview image that is being displayed, the CPU 111 hides the file name display region 303.

A page number display region 304 is a display region indicating what number-th page preview image is the preview image A 301 that is being displayed on the display 120. When a page that is being displayed is changed, the CPU 111 determines what number-th page preview image is the preview image which is displayed on the display 120 and updates the display content of the page number display region 304.

A total page count display region 305 is a display region for displaying the total number of pages of preview images. For example, FIG. 3A indicates that the first page of a total of 100 pages of preview images is being displayed on the display 120.

A “page deletion” button 306 is a button for deleting a page corresponding to the preview image A 301 that is being displayed from image data. When the user presses this button, the CPU 111 displays a deletion confirmation screen (not illustrated) for causing the user to select whether to delete the corresponding page from image data, in such a way as to superpose the deletion confirmation screen on the preview screen.

A preview image enlargement button 307 is a button for displaying, in an enlarged manner, images of the preview image A 301 and the preview image B 302 that are being displayed in the preview screen. When the user presses this button, the CPU 111 enlarges the preview image A 301 and the preview image B 302 to a predetermined display size and displays the enlarged preview images. A preview image reduction button 308 is a button for displaying, in a reduced size, images of the preview image A 301 and the preview image B 302 that are being displayed in the preview screen. When the user presses this button, the CPU 111 reduces the preview image A 301 and the preview image B 302 to a predetermined display size and displays the reduced preview images.

The enlargement or reduction of a preview image can be performed not only according to the above-mentioned method but also based on a touch operation which is called a pinch operation. The pinch operation is an operation of moving two fingers in such a way as to pinch the touch panel 119. An operation of moving two fingers in such a way as to decrease the interval thereof is a pinch in, and an operation of moving two fingers in such a way as to increase the interval thereof is a pinch out. For example, when the user performs a pinch in, the CPU 111 displays a preview image in a reduced manner, and, when the user performs a pinch out, the CPU 111 displays a preview image in an enlarged manner.

An “OK” button 309 is a button used to close the preview screen and shift to another screen. When the user presses this button, the CPU 111 ends the displaying of the preview screen.

As illustrated in FIG. 3A, in a case where a file that is being displayed is configured with a plurality of preview images, it is impossible to display all of the preview images in one screen. Therefore, to cause an intended preview image to be displayed on the display 120, the user performs a flick operation 310 on the touch panel 119 to scroll-display the preview screen. FIG. 3A illustrates an example in which the user has performed the flick operation 310 at an intended portion in a region in which preview images are displayed on the display 120. When the user performs a flick operation to the left, preview images that are being displayed are scroll-displayed to the left, so that a screen illustrated in FIG. 3B is displayed on the display 120. FIG. 3B indicates that a part of the preview image A 301, which has been displayed in FIG. 3A, becomes hidden and the preview image B 302, a part of which has been hidden, becomes displayed.

In the present exemplary embodiment, the method for scrolling preview images includes the following two methods besides the flick operation. However, the method for scrolling preview images is not limited to these total of three methods including the flick operation.

The first method is a method in which the user performs a drag operation at an intended portion in a region in which preview images are displayed on the display 120. Preview images are scroll-displayed according to a distance by which the user has moved the finger from the position of pressing to the position of releasing.

The second method is a method in which the user presses a scroll button 315 displayed on the display 120. More specifically, the user presses a displayed portion of the scroll button 315 (a left or right arrow key) on the display 120, and then keeps the pressed state of the scroll button 315. According to a time during which the user has continued pressing of the scroll button 315, the image processing apparatus 101 determines the amount of movement of preview images that are being displayed and performs scroll display.

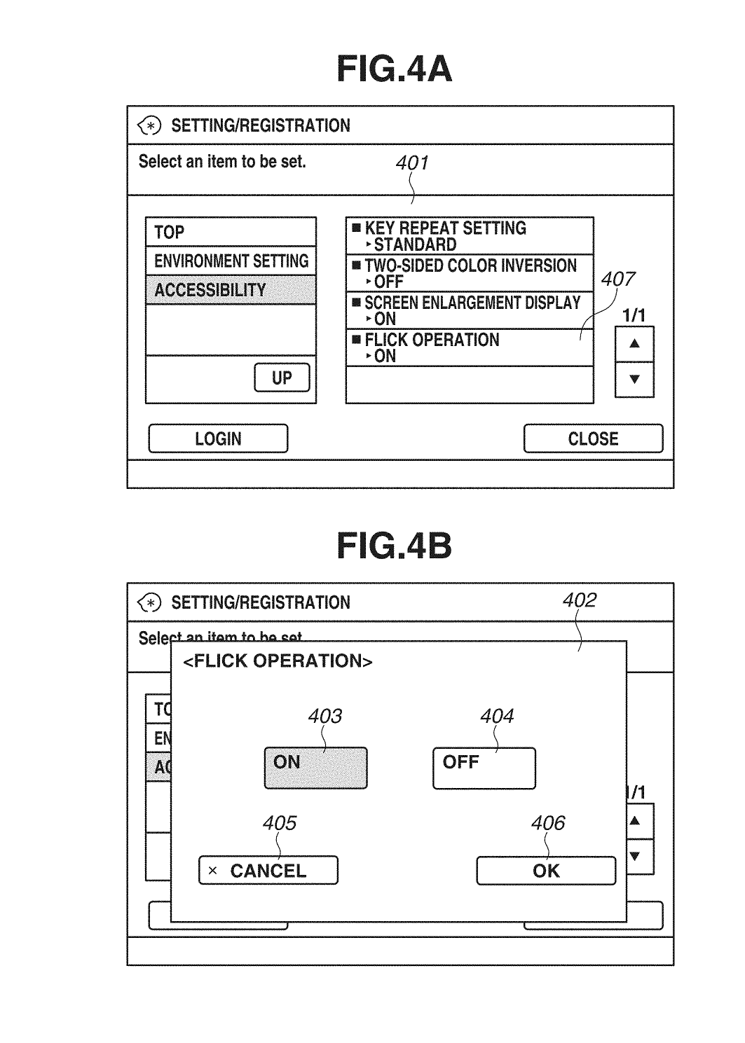

The method used for the user to set enablement/disablement of a flick operation is described with reference to FIGS. 4A and 4B.

FIGS. 4A and 4B each illustrate an example of a screen which is displayed on the display 120 when the user sets enablement/disablement of a flick operation.

FIG. 4A illustrates a screen example indicating a “setting/registration” screen 401 which is displayed on the display 120 of the image processing apparatus 101. The “setting/registration” screen 401 is a screen used to perform settings concerning the entire image processing apparatus 101, such as displaying and inputting. The “setting/registration” screen 401 is displayed when the user performs a predetermined operation in a menu screen (not illustrated) or when the user presses a button provided in the image processing apparatus 101.

The screen illustrated in FIG. 4B is a “flick operation” screen 402 which is displayed on the display 120 when the user has performed a tap operation on a “flick operation” button 407 in the “setting/registration” screen 401. The flick operation is set to ON during factory shipment, and the factory default setting value thereof is stored in the ROM 113.

The “flick operation” screen 402, which is a screen used to set the flick operation to “ON” or “OFF”, is popped up as illustrated in FIG. 4B. When, after performing a tap operation on an “ON” button 403, the user performs a tap operation on an “OK” button 406, the flick operation is set as enabled. When, after performing a tap operation on an “OFF” button 404, the user performs a tap operation on the “OK” button 406, the flick operation is set as disabled.

A “cancel” button 405 is a button used to end the “flick operation” screen 402 and display the “setting/registration” screen 401 on the display 120. When the user presses the “cancel” button 405, the setting value is set to the value last set in the “flick operation” screen 402.

The “OK” button 406 is a button used to end the “flick operation” screen 402 and display the “setting/registration” screen 401 on the display 120. When detecting a tap operation performed on the “OK” button 406, the CPU 111 stores, in the RAM 112, the setting value set in the “flick operation” screen 402.

In the present exemplary embodiment, enablement/disablement of an input that is based on a flick operation and a drag operation is set in the “flick operation” screen 402. More specifically, in a case where a flick operation is set as enabled, performing a flick operation and a drag operation causes a screen to be scroll-displayed. On the other hand, in a case where a flick operation is set as disabled, scroll display that is based on a flick operation and a drag operation is not performed. If a flick operation is set as disabled in the “flick operation” screen 402, an input that is based on not only a flick operation and a drag operation but also an operation other than a tap operation, such as a pinch operation, can be set as disabled.

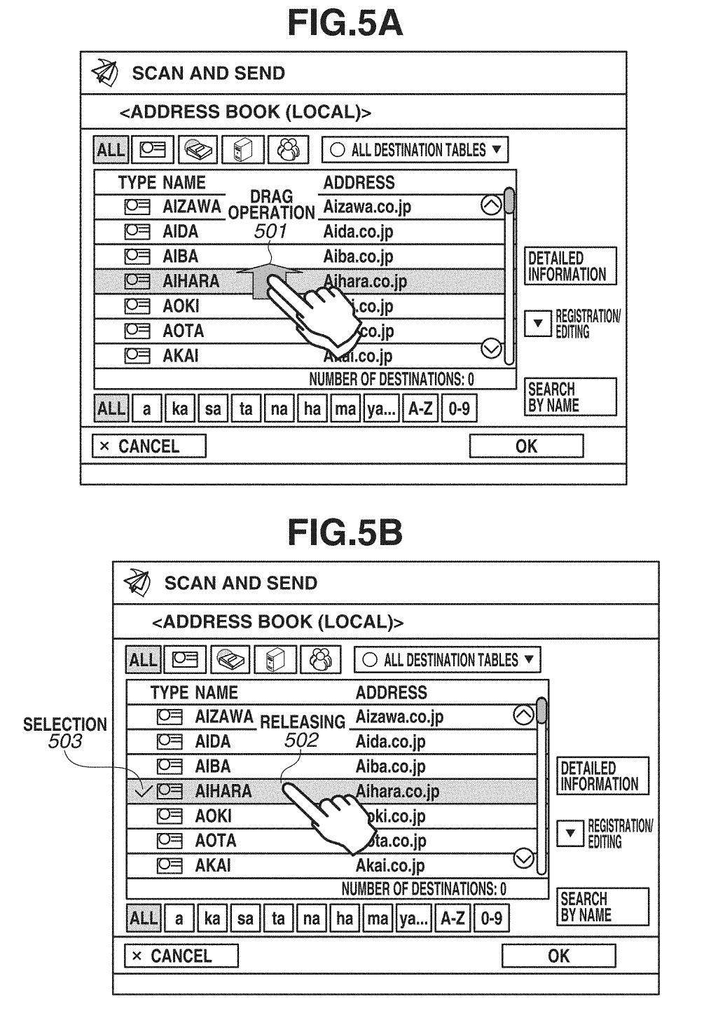

First, a behavior of the address book screen taken when a flick operation is set as disabled is described with reference to FIGS. 5A and 5B. FIG. 5A illustrates a screen which is displayed when the user has pressed “AIHARA” and then has moved the fingertip in a direction 501. In a case where a flick operation is set as disabled, even when the user has moved the fingertip in the direction 501, the destination list is not scroll-displayed. Accordingly, destinations from “AIZAWA” to “AKAI” continue being displayed in the address book screen.

Moreover, FIG. 5B illustrates a screen which is displayed when the user has returned the fingertip, which has been moved in the direction 501, to the position of “AIHARA” and then has performed releasing 502 therefrom. According to releasing of the fingertip, a selection icon 503 is displayed on the left side of “AIHARA”. Even if, after pressing “AIHARA”, the user has inadvertently moved the fingertip, when the user has released the finger at a region indicated as “AIHARA”, the image processing apparatus 101 selects “AIHARA”.

In this way, in a case where a flick operation is set as disabled, even if, after pressing a touch panel, the user has inadvertently moved the finger, a screen which is displayed on the display 120 is not scroll-displayed. Moreover, when the user has released the finger at a region in which a destination pressed by the fingertip is displayed, the image processing apparatus 101 selects the destination indicated at the position pressed by the fingertip.

On the other hand, with regard to a preview screen for displaying preview images, as with a case where a flick operation is set as enabled, upon detection of a flick operation, preview images which are displayed on the display 120 are scroll-displayed.

In a case where a flick operation is set as disabled, when detecting a flick operation at a given region, the image processing apparatus 101 scroll-displays a screen which is displayed on the display 120. On the other hand, even when detecting a flick operation at the other regions, the image processing apparatus 101 does not perform scroll display. This enables performing setting such that, out of regions available for performing scroll display that is based on a flick operation, scroll display that is based on a flick operation is not performed at some regions and scroll display that is based on a flick operation is performed at the other regions.

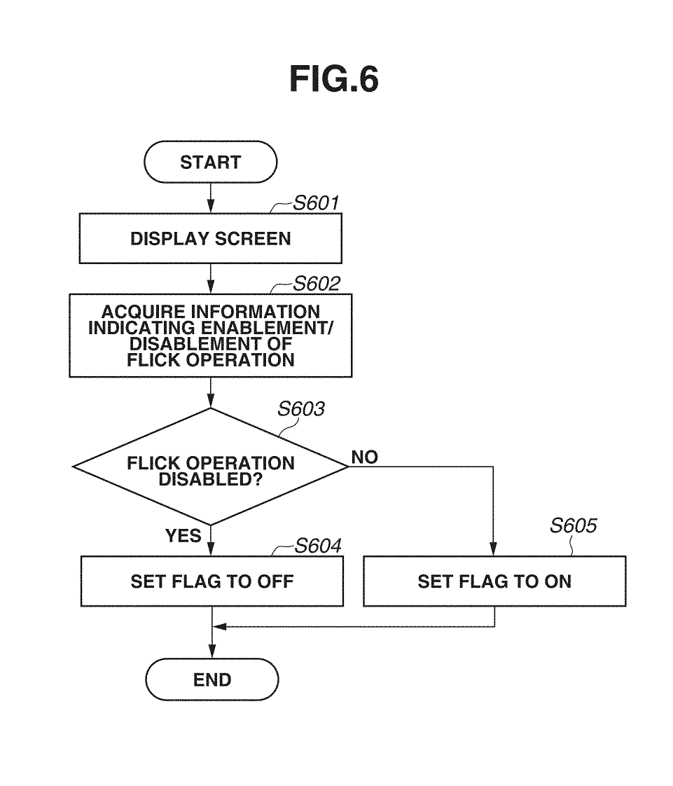

FIG. 6 is a flowchart illustrating processing which the image processing apparatus 101 performs when displaying, on the display 120, a screen including a region available for performing scroll display that is based on a flick operation. Each step illustrated in FIG. 6 is processed by the CPU 111 executing a program stored in the ROM 113 or the external memory 121.

In step S601, the CPU 111 displays, on the display 120, a screen including a region available for performing scroll display that is based on a flick operation. The screen which is displayed on the display 120 in step S601 is, for example, the address book screen illustrated in FIGS. 2A to 2E or the preview screen illustrated in FIGS. 3A and 3B. In step S601, the CPU 111 sends a control signal to the display control unit 116. The display control unit 116 generates image data according to the signal received from the CPU 111 and displays a screen represented by the image data on the display 120.

In step S602, the CPU 111 acquires a setting of enablement/disablement of a flick operation from the RAM 112. The setting of enablement/disablement of a flick operation acquired in step S602 is a value set in the “flick operation” screen 402 illustrated in FIG. 4B.

In step S603, the CPU 111 determines whether a flick operation is set as disabled based on the set value acquired in step S602. If, in step S603, it is determined that a flick operation is set as disabled (YES in step S603), then in step S604, the CPU 111 sets a flag for managing enablement/disablement of a flick operation in the screen displayed in step S601 to OFF, and then ends the processing illustrated in the present flowchart. If, in step S603, it is determined that a flick operation is set as enabled (NO in step S603), then in step S605, the CPU 111 sets the flag for managing enablement/disablement of a flick operation in the screen displayed in step S601 to ON, and then ends the processing illustrated in the present flowchart.

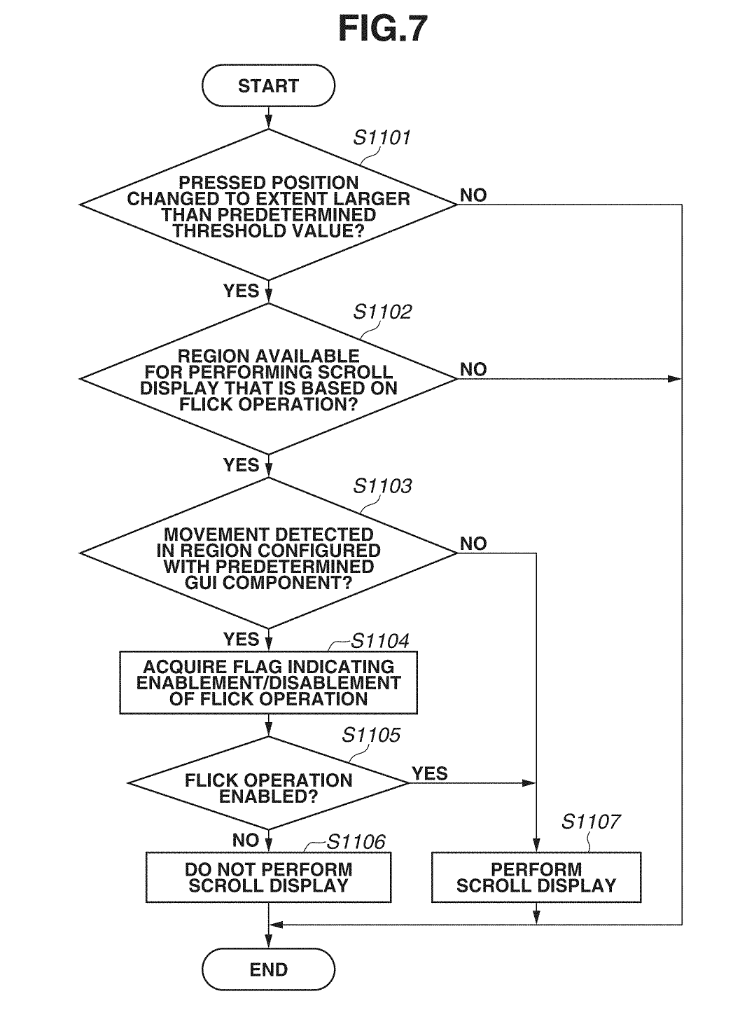

FIG. 7 is a flowchart illustrating processing which the CPU 111 performs when having detected a movement of the pressed position on the touch panel 119 in the image processing apparatus 101 according to the first exemplary embodiment. Each step illustrated in FIG. 7 is processed by the CPU 111 executing a program stored in the ROM 113 or the external memory 121.

In step S1101, the CPU 111 determines whether the pressed position has changed to an extent larger than a predetermined threshold value. The CPU 111 acquires, from the touch panel 119, information indicating a pressed position on the touch panel 119, i.e., a touch position. The CPU 111 determines whether the pressed position has changed to an extent larger than the predetermined threshold value based on the information acquired from the touch panel 119. If, in step S1101, it is determined that the pressed position on the touch panel 119 has not changed to an extent larger than the predetermined threshold value (NO in step S1101), the CPU 111 ends the processing illustrated in the present flowchart.

If it is determined that the pressed position on the touch panel 119 has changed to an extent larger than the predetermined threshold value (YES in step S1101), then in step S1102, the CPU 111 determines whether a region to which the movement of the pressed position has been detected is a region available for performing scroll display that is based on a flick operation. The region available for performing scroll display that is based on a flick operation is, for example, a destination list in the address book screen or a preview image display region in the preview screen. If the region to which the movement of the pressed position has been detected is not the region available for performing scroll display that is based on a flick operation (NO in step S1102), the CPU 111 ends the processing illustrated in the present flowchart.

If the region to which the movement of the pressed position has been detected is the region available for performing scroll display that is based on a flick operation (YES in step S1102), then in step S1103, the CPU 111 determines whether the detected movement has been performed in a region configured with a predetermined GUI component. A GUI component refers to a component configuring a screen which is displayed on the display 120. For example, the GUI component includes a “list” component for displaying a list of destinations, a “button” component for receiving a tap operation from the user, and a “preview” component for displaying preview images. The predetermined GUI component is a GUI component in which, upon detection of a tap operation, the CPU 111 selects an item on which the tap operation has been performed and, upon detection of a flick operation, the CPU 111 scroll-displays an item on which the flick operation has been performed. For example, a “list” component for displaying a destination list is the predetermined GUI component.

If, in step S1103, it is determined that the GUI component in which the movement has been detected is not the predetermined GUI component (NO in step S1103), the CPU 111 performs processing in step S1107, which is described below, and then ends the processing illustrated in the present flowchart. In other words, if the detected flick operation is an operation performed on the “preview” component, which is not the predetermined GUI component, the CPU 111 scroll-displays a preview screen and then ends the processing illustrated in the present flowchart. In this way, even in a case where a flick operation is set as disabled, upon detection of a flick operation performed on a GUI component other than the predetermined GUI component, the CPU 111 performs scroll display.

If, in step S1103, it is determined that the GUI component in which the movement has been detected is the predetermined GUI component (YES in step S1103), then in step S1104, the CPU 111 acquires a value of the flag indicating enablement/disablement of a flick operation stored in the RAM 112. For example, upon detection of a flick operation performed on a destination list in the address book screen, the CPU 111 checks the flag set in step S604 or S605.

In step S1105, the CPU 111 refers to the value of the flag acquired in step S1104 to determine whether a flick operation is enabled. If it is determined that a flick operation is enabled (YES in step S1105), the CPU 111 performs processing in step S1107. If it is determined that a flick operation is disabled (NO in step S1105), the CPU 111 performs processing in step S1106.

In a case where a flick operation is enabled, then in step S1107, the CPU 111 performs scroll display that is based on the detected flick operation, and then ends the processing illustrated in the present flowchart.

In a case where a flick operation is disabled, then in step S1106, the CPU 111 does not perform scroll display that is based on the detected flick operation, and then ends the processing illustrated in the present flowchart. In other words, in a case where a flick operation is set as disabled, even when detecting a flick operation performed on a region configured with a GUI component called a “list” component of the address book screen, the CPU 111 does not perform scroll display.

According to steps S1103 to S1107, in a case where a flick operation is set as disabled, even when detecting a flick operation performed on a predetermined GUI component, the CPU 111 does not perform scroll display, and when detecting a flick operation performed on a component other than the predetermined GUI component, the CPU 111 performs scroll display.

In the present exemplary embodiment, in a case where a flick operation is set as enabled, at all of the regions available for performing scroll display that is based on a flick operation, the CPU 111 performs scroll display that is based on a flick operation.

Furthermore, in a case where a flick operation is set as disabled, even when detecting a flick operation at a region configured with a predetermined GUI component out of regions available for performing scroll display that is based on a flick operation, the CPU 111 does not perform scroll display. On the other hand, when detecting a flick operation at a region in which the predetermined GUI component is not used, the CPU 111 performs scroll display. This enables performing setting such that, even when detecting a flick operation at some regions out of regions available for performing scroll display that is based on a flick operation, the CPU 111 does not perform scroll display of a screen and, when detecting a flick operation at the other regions, the CPU 111 performs scroll display of a screen.

In the present exemplary embodiment, the predetermined GUI component is a component configuring a region available for the CPU 111 to select an item based on a tap operation and for the CPU 111 to perform scroll display based on a flick operation. Accordingly, when a flick operation is set as disabled, the CPU 111 does not perform scroll display that is based on a flick operation and performs only selection that is based on a tap operation. This enables preventing scroll display from being performed when the user has pressed the touch panel to perform a tap operation and then has inadvertently moved the fingertip.

In the first exemplary embodiment, setting enablement/disablement of a flick operation enables performing setting such that scroll display that is based on a flick operation is not performed at some regions out of regions available for performing scroll display that is based on a flick operation and scroll display that is based on a flick operation is performed at the other regions. With this configuration employed, even after a flick operation is set as disabled, scroll display that is based on a flick operation can be performed on some screens, so that the user operability can be prevented from being reduced.

In the present exemplary embodiment, a case where only one region available for performing scroll display that is based on a flick operation is present in one screen has been described for example. However, a plurality of regions available for performing scroll display that is based on a flick operation can be present in one screen. For example, suppose that a region configured with a GUI component called a “list” component and a region configured with a GUI component called a “preview” component are present in one screen. According to a flick operation being set as disabled, in one screen, scroll display that is based on a flick operation is not performed at a region configured with the “list” component and scroll display that is based on a flick operation is performed at a region configured with the “preview” component.

Furthermore, in the present exemplary embodiment, even in a case where a flick operation is set as disabled, the user is allowed to use the scroll bar 203 or the scroll button 210 to scroll-display a screen displayed on the display 120. With this configuration employed, even in a screen in which scroll display that is based on a flick operation is not performed according to a flick operation being set as disabled, the user is allowed to perform scroll display, so that the user operability can be prevented from being reduced.

Moreover, in the first exemplary embodiment, when a flick operation is set as disabled, scroll display that is based on a flick operation is not performed at a region configured with a predetermined GUI component and scroll display that is based on a flick operation is performed at a region that does not include the predetermined GUI component. Whether scroll display that is based on a flick operation is performed or not can be switched not for each region but for each screen. For example, scroll display that is based on a flick operation is not performed at a screen that includes a predetermined GUI component and scroll display that is based on a flick operation is performed at a screen that does not include the predetermined GUI component. In this case, in step S1103 illustrated in FIG. 7, the CPU 111 determines whether the detected movement has been performed in a screen that includes the predetermined GUI component. If it is determined that the detected movement has been performed in a screen that includes the predetermined GUI component, the CPU 111 performs processing in step S1104 and subsequent steps. If it is determined that the detected movement has been performed in a screen that does not include the predetermined GUI component, the CPU 111 performs processing in step S1107. This enables performing setting such that, out of screens available for performing scroll display that is based on a flick operation, scroll display that is based on a flick operation is not performed at some screens and scroll display that is based on a flick operation is performed at the other screens.

Furthermore, in the first exemplary embodiment, the address book screen and the “preview” screen have been described for example. Naturally, processing illustrated in FIG. 6 and FIG. 7 is also applicable to a different screen available for performing scroll display that is based on a flick operation. The different screen available for performing scroll display that is based on a flick operation includes, for example, a main menu screen used for the user to select a function to be used and a screen used to select a storage destination in a function which stores an image read by the scanner 122 in the external memory 121.

In the first exemplary embodiment, the preview screen has been described as a region configured with a component other than the predetermined GUI component for example. In the first exemplary embodiment, when the CPU 111 detects a flick operation at a region in which preview images are displayed, the CPU 111 scroll-displays preview images, and when the CPU 111 detects a tap operation at that region, the CPU 111 displays preview images in an enlarged manner. However, in the region configured with a component other than the predetermined GUI component, when detecting a flick operation, the CPU 111 can perform scroll display and, when detecting a tap operation, the CPU 111 does not need to switch screens displayed on the display 120.

In the first exemplary embodiment, in a case where a flick operation is set as disabled, even if a flick operation performed on a predetermined GUI component is detected, scroll display is not performed, and, when a flick operation performed on another GUI component is detected, scroll display is performed.

In a second exemplary embodiment, even in a case where a flick operation is set as disabled, in a region in which scroll display can be performed only via a flick operation, scroll display that is based on a flick operation is carried out. The region in which scroll display can be performed only via a flick operation is, for example, a region in which scroll display that is based on the scroll bar 203 or the scroll button 210 illustrated in FIG. 2B is not performed.

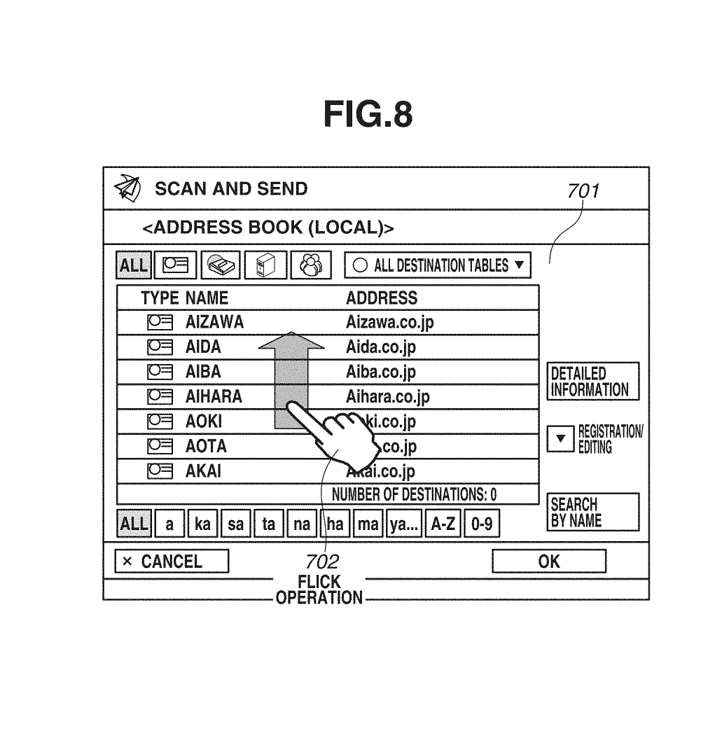

FIG. 8 illustrates an address book screen used to select a destination from the address book in the second exemplary embodiment. Unlike the address book screen in the first exemplary embodiment illustrated in FIGS. 2A to 2E, the address book screen illustrated in FIG. 8 has neither a scroll bar 203 nor a scroll button 210. Therefore, to scroll-display a destination list 701 illustrated in FIG. 8, the user has to perform a flick operation 702. In the second exemplary embodiment, even in a case where a flick operation is set as disabled, in the above-mentioned region, scroll display that is based on a flick operation is carried out.

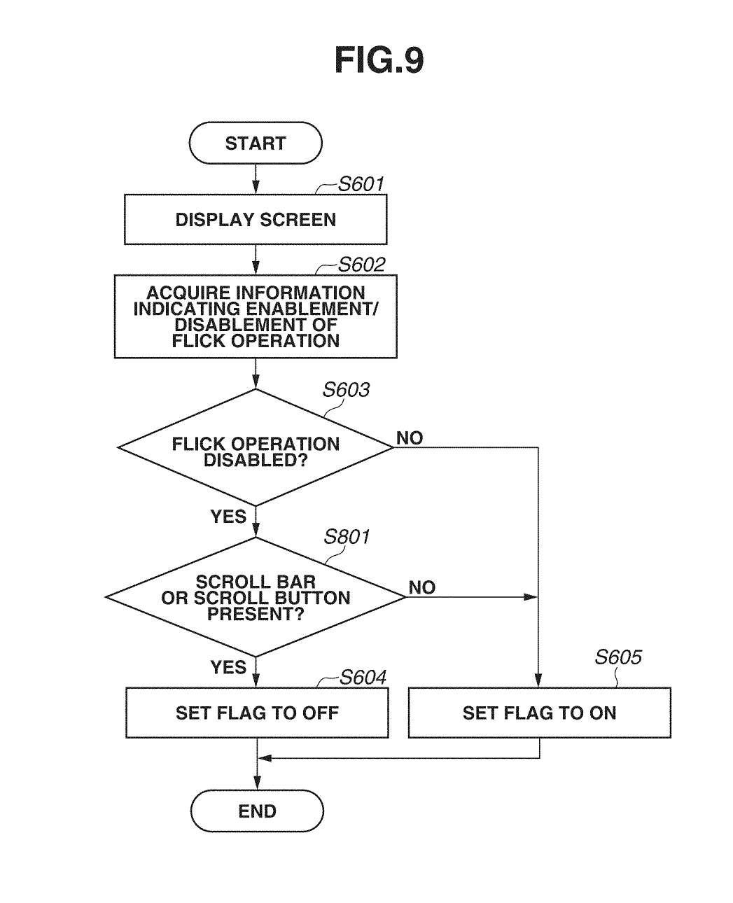

FIG. 9 is a flowchart illustrating an example of processing which the CPU 111 performs when displaying, on the display 120, a screen including a region available for performing scroll display that is based on a flick operation in the image processing apparatus 101 according to the second exemplary embodiment. Each step illustrated in FIG. 9 is processed by the CPU 111 executing a program stored in the ROM 113 or the external memory 121. The flowchart of FIG. 9 is described as follows. Furthermore, processing in steps S601 to S605 is similar to that in the respective same steps illustrated in the flowchart of FIG. 6, and, therefore, the description thereof is omitted.

If, in step S603, it is determined that a flick operation is set as disabled (YES in step S603), then in step S801, the CPU 111 determines whether a scroll bar or a scroll button is present in the screen displayed in step S601. Here, the CPU 111 determines whether a scroll bar or a scroll button used to scroll-display a region configured with a predetermined GUI component available for performing scroll display that is based on a flick operation, out of GUI components configuring the screen displayed in step S601, is present. The predetermined GUI component is a GUI component, such as a “list component” in the first exemplary embodiment, in which, upon detection of a tap operation, an item is selected and, upon detection of a flick operation, scroll display is performed. If it is determined that a scroll bar or a scroll button is present (YES in step S801), the CPU 111 advances the processing to step S604. If it is determined that neither a scroll bar nor a scroll button is present (NO in step S801), the CPU 111 advances the processing to step S605.

After a screen is displayed on the display 120, upon detection of a touch operation, the CPU 111 performs processing similar to that illustrated in FIG. 7 of the first exemplary embodiment.

In the second exemplary embodiment, in a case where a flick operation is set as disabled, in step S801, the CPU 111 determines whether a component used to perform scroll display is present in a screen which is displayed in step S601. If a GUI component used to scroll-display a region available for performing scroll display that is based on a flick operation displayed on the display 120 is displayed in the screen, scroll display that is based on a flick operation is set as disabled. On the other hand, if a GUI component used to scroll-display the above-mentioned region is not displayed in the screen, scroll display that is based on a flick operation is set as enabled. With this configuration employed, even in a case where a flick operation is set as disabled, in a region in which scroll display cannot be performed by a method other than a flick operation, scroll display that is based on a flick operation can be performed.

In the present exemplary embodiment, with respect to each region configured with a GUI component available for performing scroll display that is based on a flick operation, the CPU 111 determines whether a GUI component used to scroll-display the region by a method other than a flick operation is present. Accordingly, in a case where there are two or more regions available for performing scroll display that is based on a flick operation in one screen, the CPU 111 determines whether each region can be scroll-displayed by a method other than a flick operation. Then, with respect to only a region in which scroll display can be performed by a method other than a flick operation, the CPU 111 performs setting to prevent scroll display that is based on a flick operation from being performed.

Furthermore, while, in the description of the second exemplary embodiment, a scroll bar or a scroll button is used as an alternative method, the second exemplary embodiment is not limited to this but can be naturally applied to another alternative method.

In the first exemplary embodiment, when a flick operation is set as disabled, in a region configured with a predetermined GUI component, scroll display that is based on a flick operation is not performed and, in a region configured with another predetermined GUI component, scroll display that is based on a flick operation is carried out. In a third exemplary embodiment, in a case where a flick operation is set as disabled, a button used to switch enablement/disablement of scroll display that is based on a flick operation with respect to a screen that is being displayed is displayed. With this configuration employed, even in a case where a flick operation is set as disabled, the user is allowed to perform setting such that scroll display that is based on a flick operation can be carried out in a screen that is being displayed.

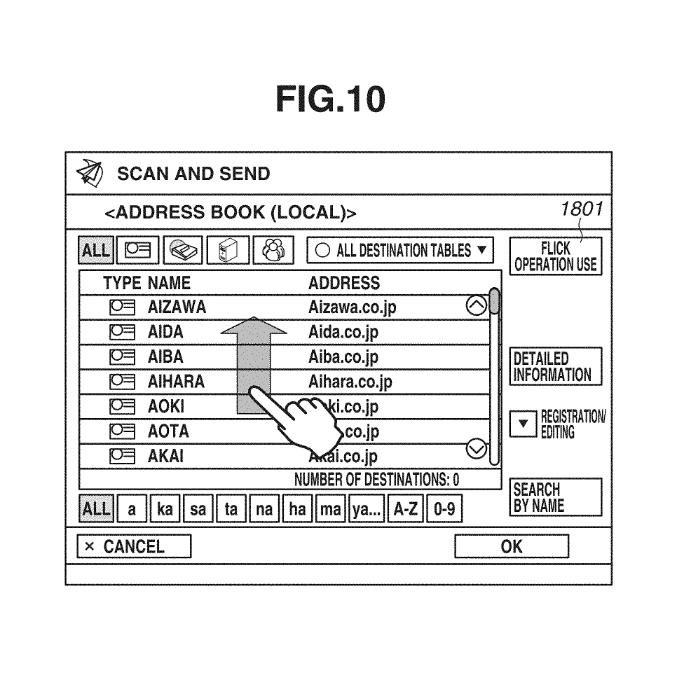

FIG. 10 is a diagram illustrating an example of a screen which the image processing apparatus 101 displays on the display 120 in the third exemplary embodiment. In the following description, an example of displaying on the display 120 in the third exemplary embodiment is described.

FIG. 10 illustrates an example of a screen indicating an address book displayed on the display 120 of the image processing apparatus 101. For example, the method for scroll-displaying an address book screen is similar to that in the first exemplary embodiment and, therefore, the description thereof is omitted.

When the user presses a “flick operation use” button 1801, the color of the “flick operation use” button 1801 is inverted. FIG. 10 illustrates a state in which a flick operation is set as disabled. When the color of the “flick operation use” button 1801 is inverted, the setting of a flick operation becomes enabled, and, upon detection of a flick operation, the CPU 111 scroll-displays a screen. In the present exemplary embodiment, the user changes enablement/disablement of a flick operation by pressing the “flick operation use” button 1801 to invert the color of the “flick operation use” button 1801. Such a configuration that, when the user presses the “flick operation use” button 1801, another screen is displayed on the display 120 to enable setting of enablement/disablement of a flick operation can be employed. Moreover, such a configuration that, when the user performs a tap operation on the “flick operation use” button 1801, a pull-down menu is displayed to enable setting of enablement/disablement of a flick operation can be employed.

Processing performed to display a screen available for performing scroll display that is based on a flick operation in the third exemplary embodiment is described with reference to FIG. 6. Here, only portions different from those in the first exemplary embodiment are described. In a case where a flick operation is set as disabled, in step S604, the CPU 111 sets the flag to OFF and displays the “flick operation use” button 1801.

Processing which the CPU 111 performs when having detected the movement of a pressed position on the touch panel 119 after displaying a screen on the display 120 is described with reference to FIG. 7. Here, only portions different from those in the first exemplary embodiment are described. In the third exemplary embodiment, without performing processing in step S1103 illustrated in FIG. 7, after performing processing in step S1102, the CPU 111 performs processing in step S1104 and subsequent steps.

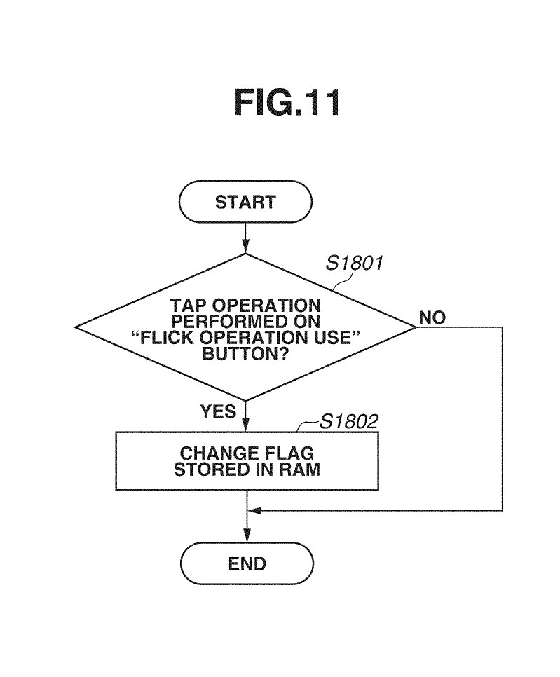

Furthermore, in the third exemplary embodiment, when having detected a tap operation performed on the “flick operation use” button 1801, the CPU 111 performs processing illustrated in FIG. 11.

A program used to perform processing illustrated in FIG. 11 is stored in the ROM 113 or the external memory 121, and the processing is implemented by the CPU 111 executing the program.

In step S1801, the CPU 111 determines whether a tap operation has been performed on the “flick operation use” button 1801. If it is determined that no tap operation has been performed on the “flick operation use” button 1801 (NO in step S1801), the CPU 111 ends the processing illustrated in the present flowchart.

If a tap operation performed on the “flick operation use” button 1801 has been detected (YES in step S1801), then in step S1802, the CPU 111 updates a flag used to manage enablement/disablement of a flick operation, which is stored in the RAM 112. For example, in a case where the flag used to manage enablement/disablement of a flick operation is previously set to OFF, the CPU 111 sets the flag to ON. In a case where the flag is previously set to ON, the CPU 111 sets the flag to OFF.

As described above, according to the image processing apparatus 101 in the third exemplary embodiment, even when a flick operation is previously set as disabled, a flick operation can be set as enabled with respect to a screen that is being displayed on the display 120. In the present exemplary embodiment, even if a flick operation is previously set as disabled in a screen that is being displayed when the “flick operation use” button 1801 is pressed, scroll display is performed upon detection of a flick operation.

Furthermore, in the third exemplary embodiment, in a case where a flick operation is set as disabled via the “flick operation” screen 402, the “flick operation use” button 1801 is displayed. Such a configuration that, even in a case where a flick operation is set as enabled via the “flick operation” screen 402, the “flick operation use” button 1801 is displayed can be employed. In other words, such a configuration that, irrespective of enablement/disablement of a flick operation, which is set via the “flick operation” screen 402, the “flick operation use” button 1801 is displayed can be employed.

In the first exemplary embodiment, in a case where a flick operation is set as disabled, in a region configured with a predetermined GUI component, scroll display that is based on a flick operation is not performed and, in a region configured with another predetermined GUI component, scroll display that is based on a flick operation is carried out. When a flick operation is set as disabled, the user cannot know in which screen scroll display that is based on a flick operation can be performed and in which screen scroll display that is based on a flick operation cannot be performed. Moreover, in a case where, after a screen is displayed, the user has become aware that a flick operation is disabled, to enable a flick operation to be used in the screen, the user has to cause the “setting/registration” screen to be displayed on the display 120 and has to perform setting thereon, and thus cannot immediately change the setting.

In a fourth exemplary embodiment, in a case where a flick operation is set as disabled, when a screen in which scroll display that is based on a flick operation can be performed is displayed, a notification screen for giving a notification that a flick operation is set as disabled is displayed. Moreover, the user is allowed to use the notification screen to set enablement/disablement of a flick operation in a screen intended to be operated.

The notification screen enables the user to become aware that, even if the user performs a flick operation in a screen intended to be displayed on the display 120, scroll display is not performed. Moreover, the user is allowed to perform setting as to whether to enable scroll display that is based on a flick operation in a screen intended to be operated. With this, when the user wants to use a flick operation in a screen intended to be operated, the user can immediately set a flick operation as enabled.

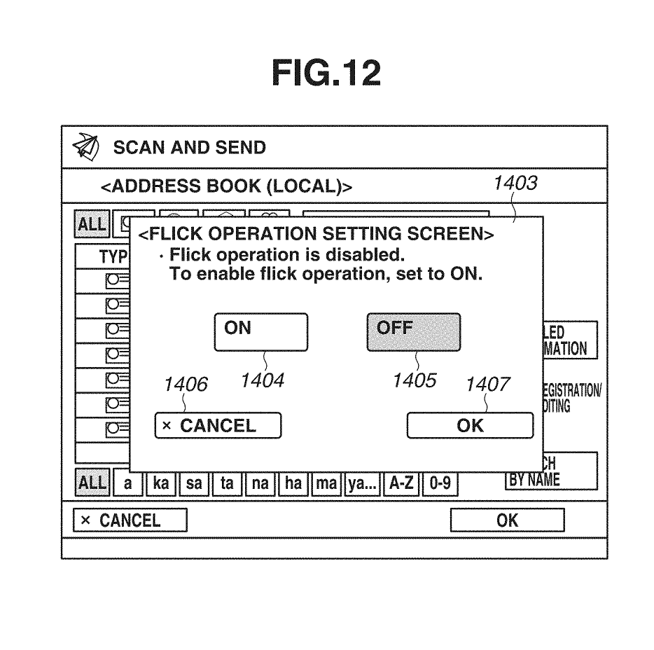

FIG. 12 illustrates an example of a screen which is displayed on the display 120 of the image processing apparatus 101 in the present exemplary embodiment.

FIG. 12 illustrates a “flick operation setting” screen 1403, which is displayed on the display 120 after the user performs a tap operation on the “address book” button 1402 in the “scan and send” screen 1401. The “flick operation setting” screen 1403 is popped up on the address book screen according to a tap operation being performed on the “address book” button 1402. The “flick operation setting” screen 1403 is a screen for notifying the user that scroll display that is based on a flick operation is set as disabled. Moreover, the “flick operation setting” screen 1403 is also a screen which allows the user to perform setting as to whether to enable a flick operation in a screen which is displayed after an “OK” button 1407 is tapped.

An “ON” button 1404 is a button used to set a flick operation as enabled. An “OFF” button 1405 is a button used to set a flick operation as disabled.

A “cancel” button 1406 is a button used to close the “flick operation setting” screen 1403 and display the address book screen on the display 120. When a tap operation has been performed on the “cancel” button 1406, the setting value is not changed and is still set to the value set in the “flick operation” screen 402. The default value thereof is stored in the ROM 113.

When the user presses the “OK” button 1407, the CPU 111 closes the “flick operation setting” screen 1403 and displays the address book screen on the display 120. According to the “OK” button 1407 being pressed, the CPU 111 stores the setting set in the “flick operation setting” screen 1403 in the RAM 112.

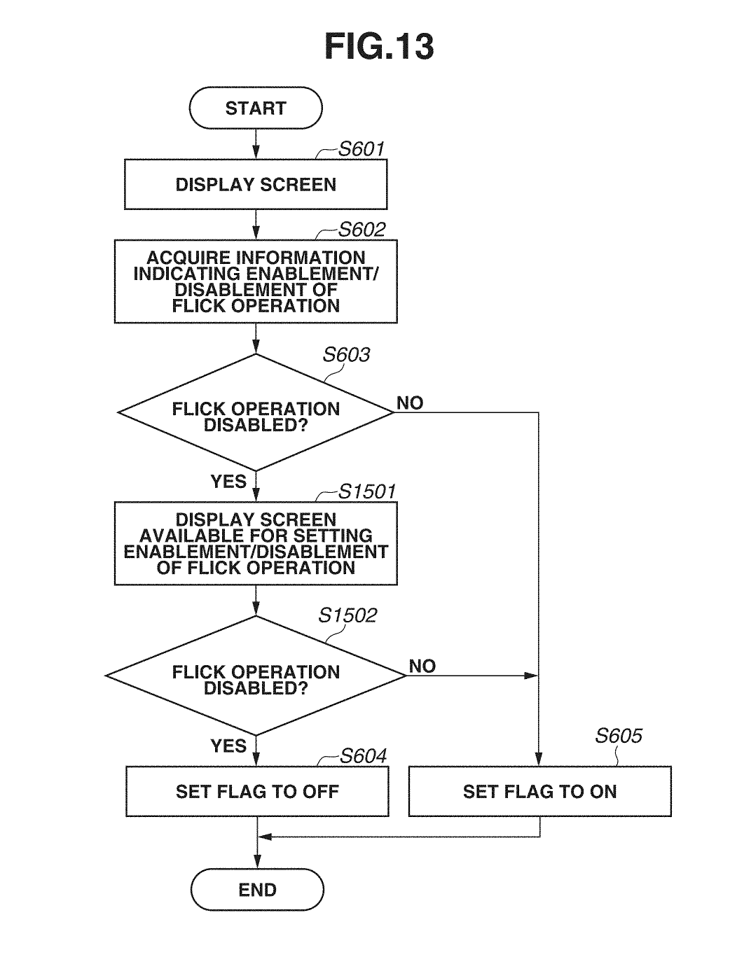

FIG. 13 is a flowchart illustrating an example of processing performed when the image processing apparatus 101 displays, on the display 120, a screen in which scroll display that is based on a flick operation can be performed in the fourth exemplary embodiment. Each step illustrated in FIG. 13 is implemented by the CPU 111 executing a program stored in the ROM 113 or the external memory 121. The flowchart of FIG. 13 is described as follows. Furthermore, processing in steps S601 to S605 is similar to that in the respective same steps illustrated in the flowchart of FIG. 6, and, therefore, the description thereof is omitted.

If it is determined that a flick operation is set as disabled (YES in step S603), then in step S1501, the CPU 111 displays the “flick operation setting” screen 1403 on the display 120.

According to a tap operation performed on the “OK” button 1407 or the “cancel” button 1406 being detected, in step S1502, the CPU 111 determines whether a flick operation is set as disabled. For example, in a case where a tap operation is performed on the “OK” button 1407 with the “ON” button 1404 selected in the “flick operation setting” screen 1403, the CPU 111 determines that a flick operation is set as enabled. In a case where the “OK” button 1407 is pressed with the “OFF” button 1405 selected in the “flick operation setting” screen 1403 or in a case where the “cancel” button 1406 is pressed, the CPU 111 determines that a flick operation is set as disabled.

If it is determined that a flick operation is set as disabled (YES in step S1502), the CPU 111 performs processing in step S604. If it is determined that a flick operation is set as enabled (NO in step S1502), the CPU 111 performs processing in step S605.

Processing which the CPU 111 performs when having detected the movement of a pressed position on the touch panel 119 in the fourth exemplary embodiment is described with reference to FIG. 7. Here, only portions different from those in the first exemplary embodiment are described. In the present exemplary embodiment, without performing processing in step S1103 illustrated in FIG. 7, after performing processing in step S1102, the CPU 111 performs processing in step S1104 and subsequent steps.

As described above, according to the image processing apparatus 101 in the fourth exemplary embodiment, in a case where a flick operation is set as disabled, when a screen in which scroll display that is based on a flick operation can be performed is displayed, a screen used to set enablement/disablement of a flick operation is displayed. With this configuration employed, without having to display the “setting/registration” screen and change the setting therein, the user is able to set a flick operation in a screen displayed on the display 120 as enabled.

Furthermore, while, in the description of the above fourth exemplary embodiment, pop-up display is performed each time for example, pop-up display can be performed once per several times. For example, in the “flick operation setting” screen 1403, a checkbox used to perform setting as to whether to display the pop-up screen the next time and subsequent times can be displayed.

Moreover, in the fourth exemplary embodiment, in a case where a flick operation is set as disabled in the “flick operation” screen 402, the CPU 111 displays the “flick operation setting” screen 1403. Even in a case where a flick operation is set as enabled, the “flick operation setting” screen 1403 can be displayed when a screen in which scroll display that is based on a flick operation can be performed is displayed. With this configuration employed, irrespective of the setting of enablement/disablement of a flick operation, the user is able to perform setting as to whether to perform scroll display that is based on a flick operation when a screen in which scroll display that is based on a flick operation can be performed is displayed.

In the first exemplary embodiment, in a case where a flick operation is set as disabled, scroll display that is based on a flick operation performed on a predetermined GUI component is not performed and scroll display that is based on a flick operation performed on another predetermined GUI component is carried out. In a fifth exemplary embodiment, the user is allowed to set enablement/disablement of a flick operation with respect to each GUI component, each function of the image processing apparatus 101, and each screen. With this configuration employed, the user is able to more finely set enablement/disablement of a flick operation.

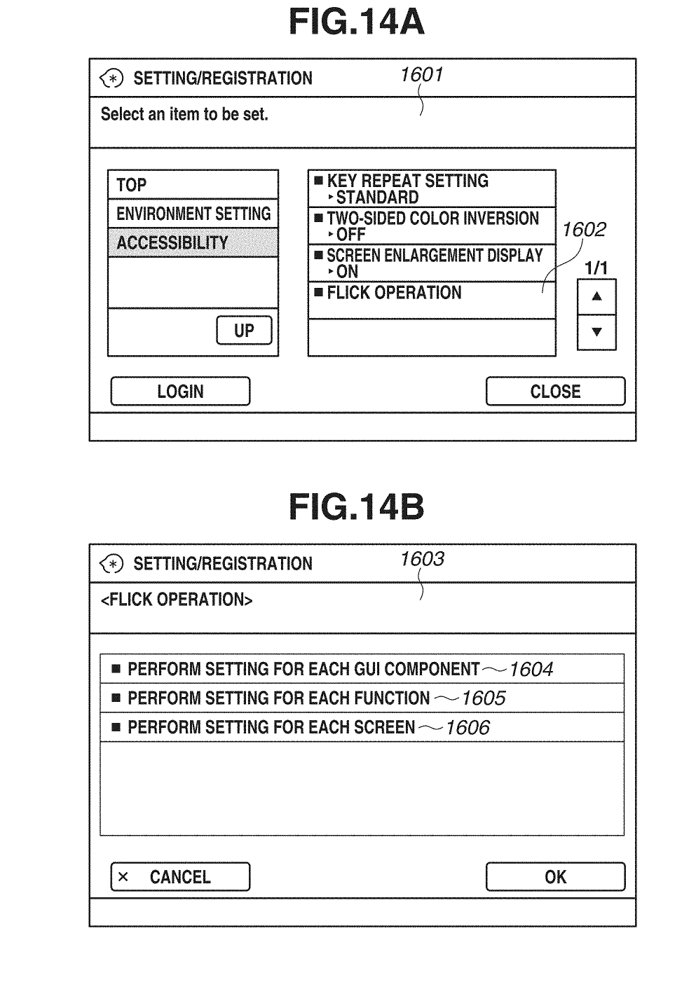

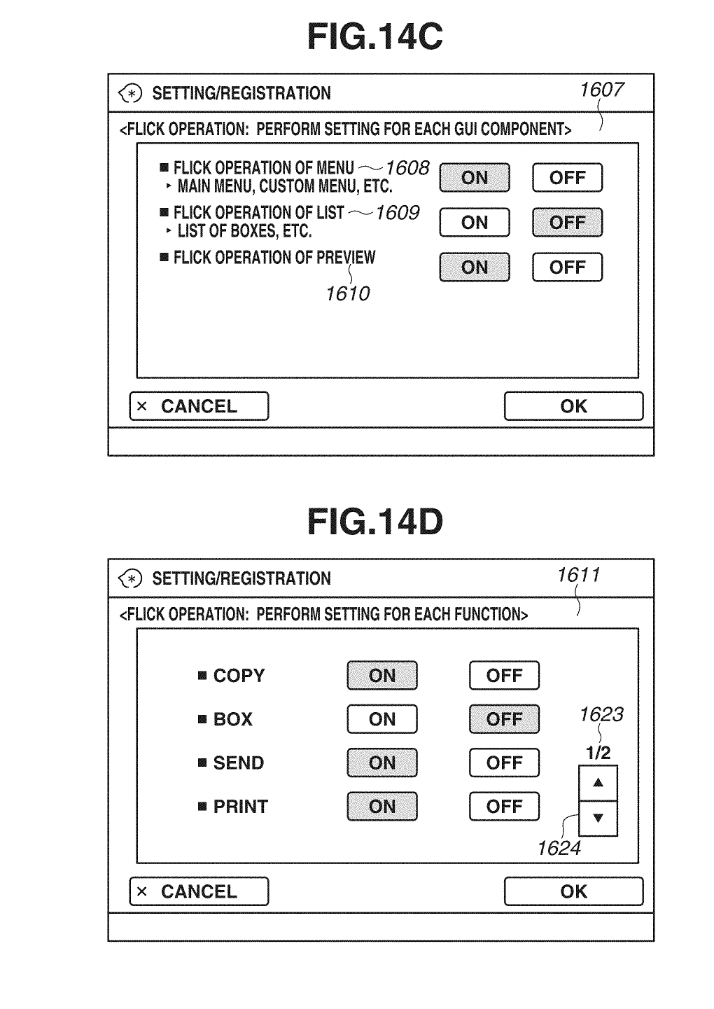

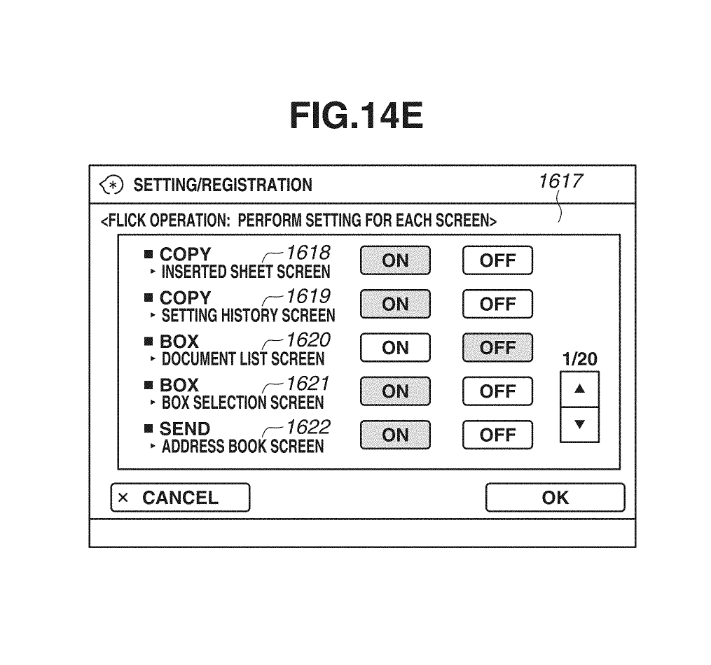

FIGS. 14A, 14B, 14C, 14D, and 14E are diagrams each illustrating an example of a screen which is displayed on the display 120 of the image processing apparatus 101 in the fifth exemplary embodiment.

FIG. 14A illustrates an example of a screen indicating a “setting/registration” screen 1601 displayed on the display 120 of the image processing apparatus 101. According to the user performing a tap operation on a “flick operation” button 1602, a “flick operation” screen 1603 illustrated in FIG. 14B is displayed on the display 120.

The “flick operation” screen 1603 illustrated in FIG. 14B includes a “perform setting for each GUI component” item 1604, a “perform setting for each function” item 1605, and a “perform setting for each screen” item 1606. When the user performs a tap operation on each item, the respective screen illustrated in FIGS. 14C to 14E that corresponds to the respective item is displayed on the display 120.

A “perform setting for each GUI component” screen 1607 illustrated in FIG. 14C is a screen which is displayed on the display 120 according to the user selecting the “perform setting for each GUI component” item 1604. The “perform setting for each GUI component” screen 1607 includes a “flick operation of menu” item 1608, a “flick operation of list” item 1609, and a “flick operation of preview” item 1610. The “flick operation of menu” item 1608 is used to set enablement/disablement of a flick operation in a menu screen used for the user to select a function to be used. The “flick operation of list” item 1609 is used to set enablement/disablement of a flick operation with respect to a list of transmission destinations or a list of storage destinations in which to store image data read by the scanner 122 in the box function. The “flick operation of preview” item 1610 is used to set enablement/disablement of a flick operation with respect to preview images illustrated in FIGS. 3A and 3B. While, in the present exemplary embodiment, three GUI components are illustrated for example, any other GUI component available for performing scroll display that is based on a flick operation can be naturally included.

A “perform setting for each function” screen 1611 illustrated in FIG. 14D is a screen which is displayed on the display 120 according to the user selecting the “perform setting for each function” item 1605. The “perform setting for each function” screen 1611 is used to set enablement/disablement of a flick operation with respect to each type of job which the image processing apparatus 101 is able to execute. The “perform setting for each function” screen 1611 allows the user to set enablement/disablement of a flick operation with respect to each of, for example, a copy function, a box function, a send function, a print function, and a hold function.

The copy function is a function to print image data generated by reading an original with the scanner 122 on a sheet with the printer 123. The box function is a function to read out and print image data stored in a storage medium, such as the external memory 121 of the image processing apparatus 101. The send function is a function to transmit image data generated by reading an original with the scanner 122 to another image processing apparatus or an information processing apparatus such as a PC. The print function is a function to print image data received from an information processing apparatus such as a PC on a sheet with the printer 123.

A displayed page item 1623 in the “perform setting for each function” screen 1611 indicates the total number of pages of the “perform setting for each function” screen 1611 and a page number of the page that is currently displayed on the display 120. For example, in FIG. 14D, the displayed page item 1623 indicates that the “perform setting for each function” screen 1611 includes two pages in total and page 1 is currently displayed. A page switching button 1624 is a button used to switch a page of the “perform setting for each function” screen 1611 that is being displayed on the display 120.

While, in this instance, four functions are illustrated as an example, any other function can be naturally set as a target for setting of enablement/disablement of a flick operation.

A “perform setting for each screen” screen 1617 illustrated in FIG. 14E is a screen which is displayed on the display 120 according to the user selecting the “perform setting for each screen” item 1606. The “perform setting for each screen” screen 1617 is a screen enabling more finely setting enablement/disablement of a flick operation than the “perform setting for each function” screen 1611.

For example, in FIG. 14E, the “perform setting for each screen” screen 1617 enables performing setting with respect to an “inserted sheet screen” item 1618 and a “setting history screen” item 1619 of the copy function, a “document list screen” item 1620 and a “box selection screen” item 1621 of the box function, and an “address book screen” item 1622 of the send function.

The inserted sheet screen is a screen used to set interleaving paper to be inserted into between sheets output during use of the copy function. In the inserted sheet screen, a list of positions at which to insert interleaving paper set by the user is displayed.

The setting history screen is a screen used to call up and use a setting which was used during execution of a previous copy job.

The document list screen in the box function is a screen for displaying a list of documents stored in a storage medium, such as the SRAM 114 of the image processing apparatus 101. The image processing apparatus 101 is able to display (e.g., on the display 120) or print a screen selected by the user via the document list screen.

The box selection screen of the box function is a screen used to select a folder to be used from a list of folders stored in the external memory 121.

The address book screen of the send function is a screen for displaying a list of destinations registered with the address book illustrated in FIGS. 2A to 2E.

The “perform setting for each screen” screen 1617 includes a page switching button as with the “perform setting for each function” screen 1611, so that switching pages enables setting enablement/disablement of a flick operation even with respect to a screen that is not being displayed on the display 120. While, in this instance, five screens are illustrated as an example, any other screen can be naturally set as a target.

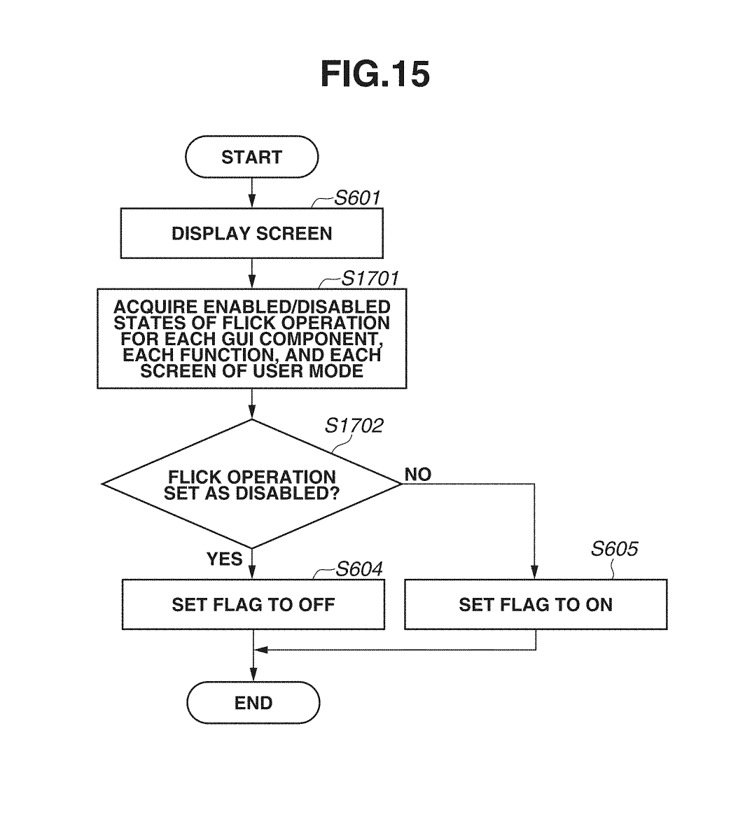

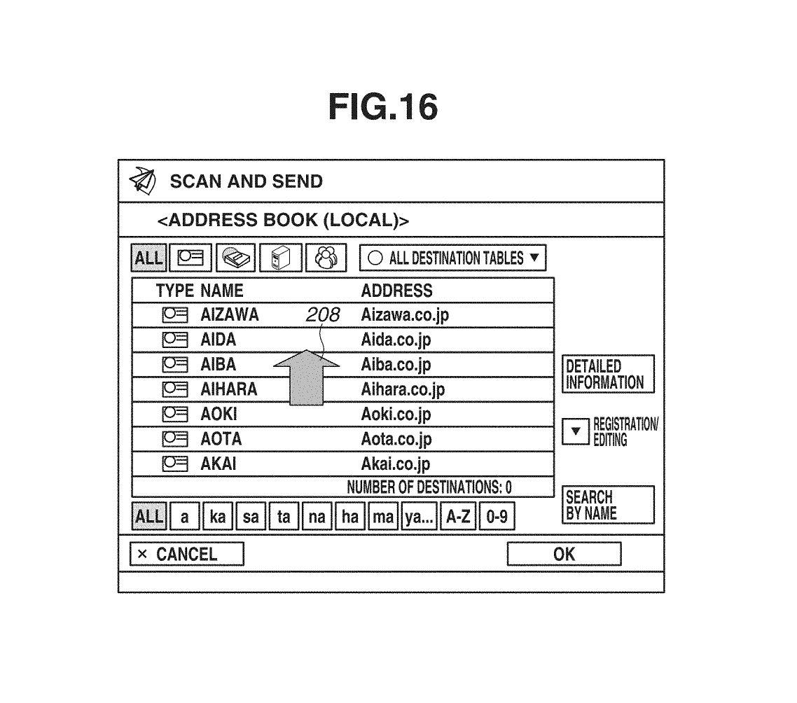

FIG. 15 is a flowchart illustrating processing performed when the image processing apparatus 101 in the fifth exemplary embodiment displays a screen on the display 120. Each step illustrated in FIG. 15 is processed by the CPU 111 executing a program stored in the ROM 113 or the external memory 121. Furthermore, processing in steps S601, S604, and S605 is similar to that in the respective same steps illustrated in the flowchart of FIG. 6, and, therefore, the description thereof is omitted.

In step S1701, the CPU 111 acquires a setting of enablement/disablement of a flick operation in the screen displayed on the display 120 in step S601.

In step S1702, the CPU 111 determines whether a flick operation in the screen displayed on the display 120 is set as disabled, based on the setting value acquired in step S1701. In step S1702, in a case where a flick operation is set as disabled with respect to any one of the GUI components, the functions, and the screens, the CPU 111 determines that a flick operation is set as disabled. For example, in a case where “copy” is set to OFF in the “perform setting for each function” screen 1611, irrespective of the settings of the “perform setting for each GUI component” screen 1607 and the “perform setting for each screen” screen 1617, the CPU 111 determines that a flick operation is set as disabled in the screen of the copy function.

Processing which the CPU 111 performs when having detected the movement of a pressed position on the touch panel 119 in the fifth exemplary embodiment is described with reference to FIG. 7. Here, only portions different from those in the first exemplary embodiment are described. In the present exemplary embodiment, without performing processing in step S1103 illustrated in FIG. 7, after performing processing in step S1102, the CPU 111 performs processing in step S1104 and subsequent steps.

As described above, according to the image processing apparatus 101 in the fifth exemplary embodiment, the user is allowed to select in which screen to enable a flick operation, and is thus able to more freely perform setting of enablement/disablement of a flick operation. Accordingly, this enables performing setting such that, out of screens in which scroll display is performed in response to detection of a flick operation, scroll display is not performed even when a flick operation is detected in some screens and scroll display is performed when a flick operation is detected in the other screens.

While the above description describes exemplary embodiments in detail, the present disclosure is not limited to these specific exemplary embodiments, but can also include various aspects, including modifications and equivalents. Moreover, some or all of the above-described exemplary embodiments can be combined as appropriate.

Furthermore, the above-described image processing apparatus 101 includes various apparatuses. For example, the image processing apparatus 101 includes not only a personal computer, a personal digital assistant (PDA), and a mobile telephone terminal but also, for example, a printer, a scanner, a facsimile machine (FAX), a copying machine, a multifunction peripheral, a camera, a video camera, and an image viewer.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the above description describes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-035934 filed Feb. 28, 2017, which is hereby incorporated by reference herein in its entirety.

What is claimed is:

1. An image processing apparatus comprising:
a display unit configured to display at least a first screen and a second screen;
a display control unit configured to scroll-display, according to a predetermined touch operation by a user on a first region of the first screen, an item that is displayed in the first region and configured to scroll-display, according to the predetermined touch operation by the user on a second region of the second screen, an item that is displayed in the second region; and
a setting unit configured to perform a setting to prevent scroll display that is based on the predetermined touch operation from being performed in the second region by the display control unit.

2. The image processing apparatus according to claim 1, further comprising a control unit configured to perform, in a case where the setting is performed by the setting unit to prevent scroll display that is based on the predetermined touch operation from being performed in the second region, control to scroll-display the item that is displayed in the first region according to the predetermined touch operation by the user on the first region and to prevent the item that is displayed in the second region from being scroll-displayed according to the predetermined touch operation by the user on the second region.

3. The image processing apparatus according to claim 1, further comprising a detection unit configured to detect a pressed position at which the display unit is pressed,
wherein the display control unit scroll-displays the item that is displayed in the first region according to a change of the pressed position detected by the detection unit in the first region becoming larger than a predetermined threshold value, and
wherein the display control unit scroll-displays the item that is displayed in the second region according to a change of the pressed position detected by the detection unit in the second region becoming larger than a predetermined threshold value.

4. The image processing apparatus according to claim 1, wherein the predetermined touch operation is one of a drag operation in which, after the display unit is pressed at a pressed position, the pressed position changes to an extent larger than a predetermined threshold value and a flick operation in which, after the display unit is pressed at a pressed position, the pressed position changes in such a way as to sweep the display unit.

5. The image processing apparatus according to claim 1,
wherein the display unit displays a screen configured with components, and
wherein the second region is a region configured by using a previously-determined component out of the components and used to display the item in a list.

6. The image processing apparatus according to claim 5, wherein the first region is a region configured with a component different from the previously-determined component and used to display a preview image of image data which is able to be printed by the image processing apparatus.

7. The image processing apparatus according to claim 1,
wherein the first region is a region in which the item that is displayed in the first region is not able to be selected according to a touch operation different from the predetermined touch operation by the user, and
wherein the second region is a region in which the item that is displayed in the second region is able to be selected according to the different touch operation by the user.

8. The image processing apparatus according to claim 7,
wherein the first region is a region in which images that are displayed in the first region are switched according to the different touch operation by the user in the first region, and
wherein the second region is a region in which images that are displayed in the second region are not switched according to the different touch operation by the user in the second region.

9. The image processing apparatus according to claim 7, wherein the different touch operation is a tap operation in which pressing on the display unit ends without a position at which the display unit is pressed changing to an extent larger than a predetermined threshold value.

10. The image processing apparatus according to claim 1,
wherein the first screen is a screen in which neither a scroll button nor a scroll bar for scroll-displaying the item that is displayed in the first region is displayed, and
wherein the second screen is a screen in which at least one of a scroll bar and a scroll button for scroll-displaying the item that is displayed in the second region is displayed.

11. The image processing apparatus according to claim 1, wherein the setting unit is configured to set whether to cause the display control unit to perform the control with respect to each screen in which scroll display is allowed to be performed according to the predetermined touch operation by the user.

12. The image processing apparatus according to claim 1, wherein, according to receiving an operation for causing the display unit to display a screen in which scroll display is allowed to be performed according to the predetermined touch operation by the user, the display unit displays a screen used to set whether to perform scroll display according to the predetermined touch operation by the user.

13. The image processing apparatus according to claim 1,
wherein the image processing apparatus is configured to execute a plurality of types of jobs, and
wherein the setting unit is configured to set whether to perform scroll display according to the predetermined touch operation by the user with respect to each of the plurality of types of jobs.

14. A control method for an image processing apparatus, the control method comprising:
displaying at least a first screen and a second screen;
scroll-displaying, according to a predetermined touch operation by a user on a first region of the first screen, an item that is displayed in the first region and scroll-displaying, according to the predetermined touch operation by the user on a second region of the second screen, an item that is displayed in the second region; and
performing a setting to prevent scroll display that is based on the predetermined touch operation from being performed in the second region.

15. A computer-readable storage medium storing computer-executable instructions that, when executed by a computer, cause the computer to perform a control method for an image processing apparatus, the control method comprising:
displaying at least a first screen and a second screen;
scroll-displaying, according to a predetermined touch operation by a user on a first region of the first screen, an item that is displayed in the first region and scroll-displaying, according to the predetermined touch operation by the user on a second region of the second screen, an item that is displayed in the second region; and
performing a setting to prevent scroll display that is based on the predetermined touch operation from being performed in the second region.
